(19) United States
(12) Patent Application Publication
(10) Pub. No.: US 2002/0091692 A1
(43) Pub. Date: Jul. 11, 2002

(54) Method and system for weather forecasting

(76) Inventors: Lester T. Yoshida, St. Louis, MO (US); Cliff R. Jones, Wildwood, MO (US); Karen S. Tracy, Wildwood, MO (US)

Correspondence Address: BRINKS HOFER GILSON & LIONE, P.O. BOX 10395, CHICAGO, IL, 60610, US

(21) Appl. No.: 09/755,815

(22) Filed: Jan. 5, 2001

(51) Int. Cl. G06F 17/30

(52) U.S. Cl. 707/9

(57) ABSTRACT

A weather-based decision making method and system utilizing an input device and at least one server configured to receive a user preference profile for a specific activity, compare the user preference profile with pre-stored forecasted weather information, and provide the user with at least one of a suggested time and a suggested location for the specific activity. The user profile includes at least one weather parameter that the system compares with existing pre-stored forecasted weather information.

### BACKGROUND OF THE INVENTION

This invention relates generally to weather forecasting and, more particularly, to methods and systems for facilitating weather related decisions through network-based technologies.

People generally have less leisure time than they prefer. For this reason, it is important that people are able to capitalize on their free time. However, time can be wasted if planned activities do not occur due to adverse weather conditions and people must reschedule. In addition, opportunities may be lost since certain activities may not be able to be rescheduled.

Further, outside business activities are sometimes dependent on weather to perform certain activities adequately. If the activities are rescheduled too late, then often times the employees must be paid regardless of the work performed. In addition, productivity may lapse since activities that could be performed in adverse weather conditions may not be staffed due to logistical problems if the activity is scheduled as a result of existing adverse weather conditions.

One way to overcome such difficulties is to plan activities in accordance with acceptable weather patterns for the planned activity. However, it is difficult to stay abreast of current and near term weather conditions due to lack of time, lack of access to reliable weather information, and other activities. For this reason, it would be desirable to have quick access to reliable weather information before the weather conditions actually occurred.

### BRIEF SUMMARY OF THE INVENTION

In an exemplary embodiment of the invention, a weather-based decision making method utilizes an input device and at least one server to receive a user preference profile for a specific activity, compare the user preference profile with pre-stored forecasted weather information, and provide the user a suggested time and/or location for the specific activity.

More particularly, the user profile includes at least one weather parameter (e.g., precipitation, wind, air temperature, humidity, location, road conditions, cross winds, visibility and time). A weather-based decision making system compares the input weather parameters with existing pre-stored forecasted weather information. The system then provides the user a time and/or location at which weather conditions are within the parameter selections made by the user. The system also updates the pre-stored forecasted weather information and compares the user profile with the updated information. The system then notifies the user of additional or canceled times and/or locations at which the specific activity can be performed, or should not be performed.

The weather-based network decision making method and system facilitate accurate planning of outside activities and events. Information is forwarded to a user regarding a time and/or location during which the indicated activity can be performed within the specified weather parameters.

### BRIEF DESCRIPTION OF THE DRAWINGS

FIG. 1 is a flow chart illustrating process steps for providing weather based decisions to a user in accordance with one embodiment of the present invention;

FIG. 2 is a simplified block diagram of a system in accordance with one embodiment of the invention;

FIG. 3 is a block diagram of a server architecture for a network based system;

FIG. 4 is a block diagram illustrating network connectivity; and

FIG. 5 is a flow chart illustrating process steps for providing weather based decisions to a user.

### DETAILED DESCRIPTION OF THE INVENTION

Set forth below is a description of exemplary methods and systems for providing pertinent and current weather related information upon the occurrence of specified weather conditions. Thus, the systems and methods provide weather decisions based on an expert weather system. While the methods and systems are sometimes described in the context of leisure activities and certain outdoor work activities, the methods and systems are not limited to practice in connection with only leisure activities and outdoor work activities. The methods and systems can be used, for example, in connection with sporting events, field trips, meetings, driving, and many other different types of activities

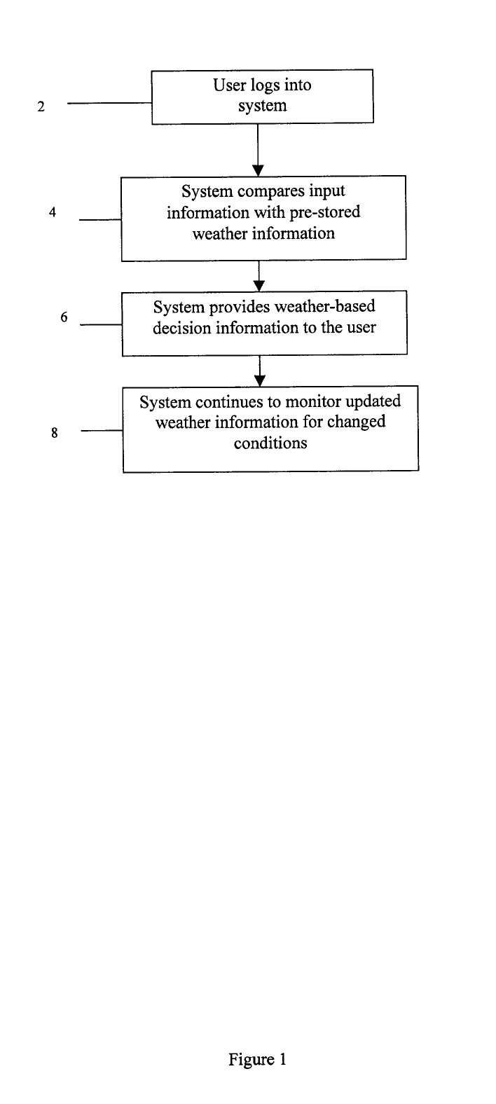

FIG. 1 is a flow chart illustrating process steps for providing weather based decisions to a user. A user logs 2 into system and the system prompts the user, e.g., via a display that prompts the user for inputs, to enter information relating to a profile representing weather preferences for each type of activity. Once the user inputs profile information, the system then compares 4 the input information with forecasted weather information stored in a weather database and provides 6 information to the user regarding the best times and/or locations for the selected activity. In one embodiment, the system provides the best time for the selected activity at a selected location. In an alternative embodiment, the system provides the best location for the selected activity at a selected time. In a still further embodiment, the system provides the best time and the best location for the selected activity. The system continues to monitor 8 the weather database as the database is updated to determine when to notify the user that input weather parameters have been met or exceeded.

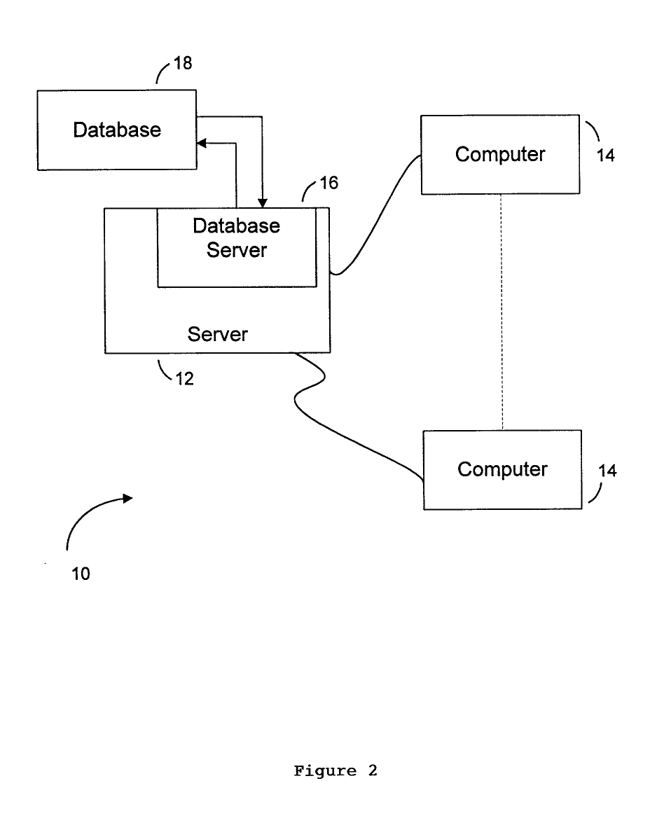

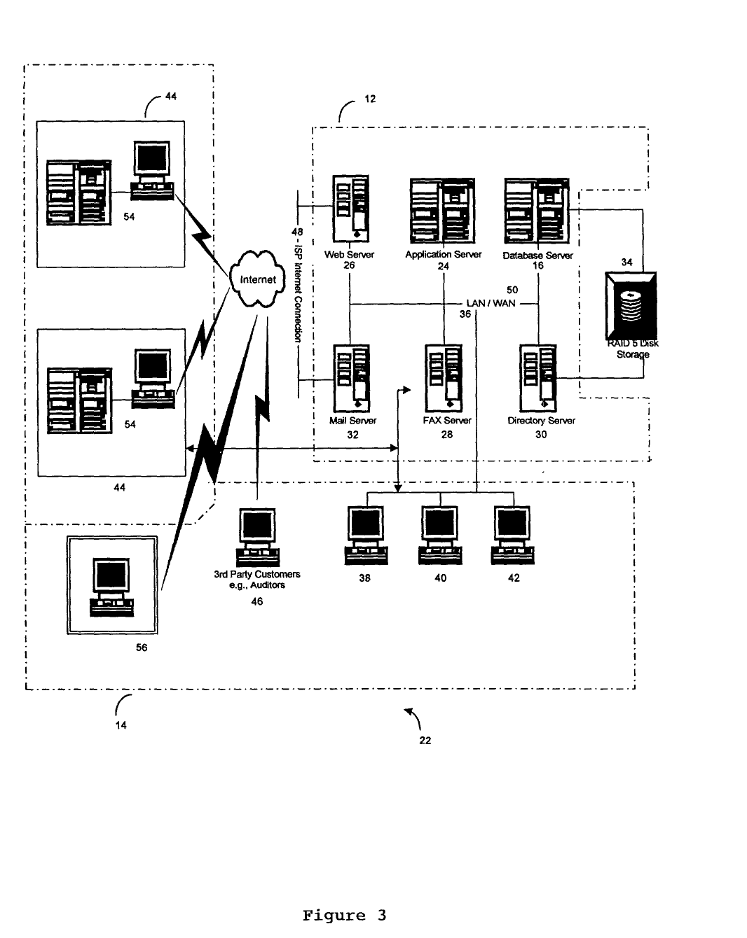

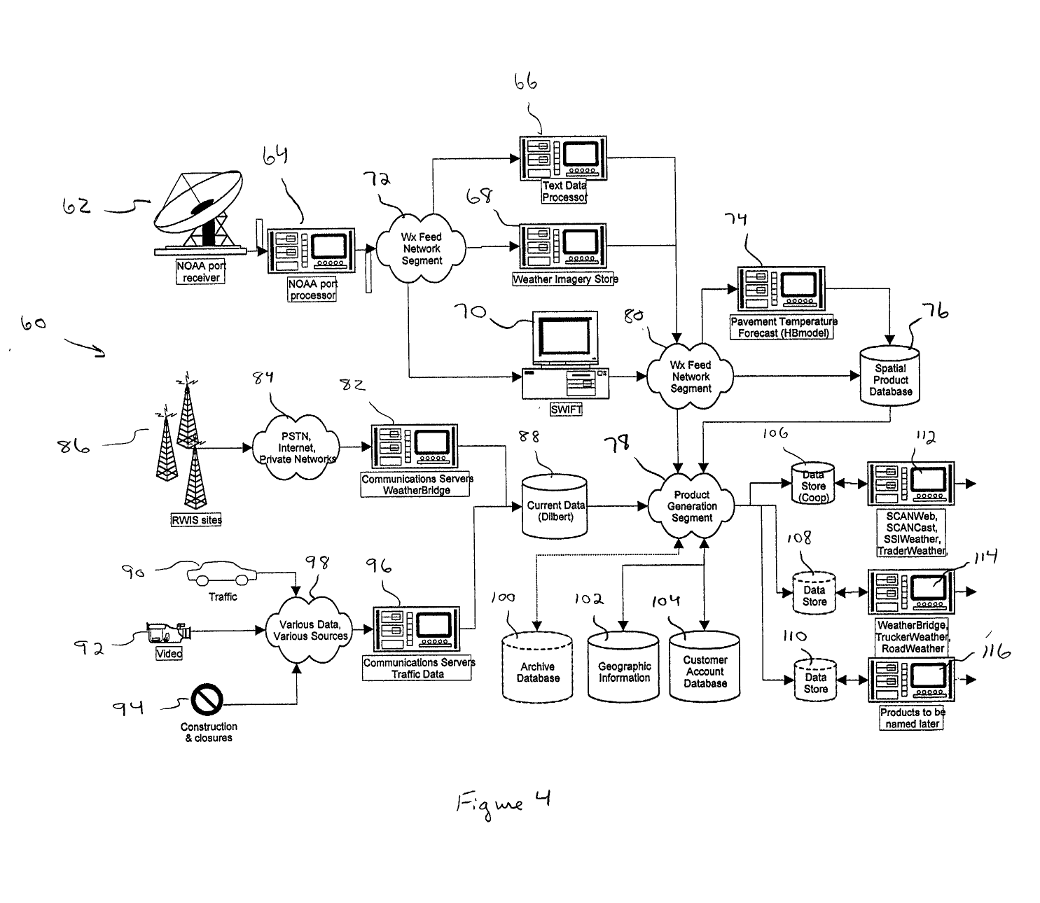

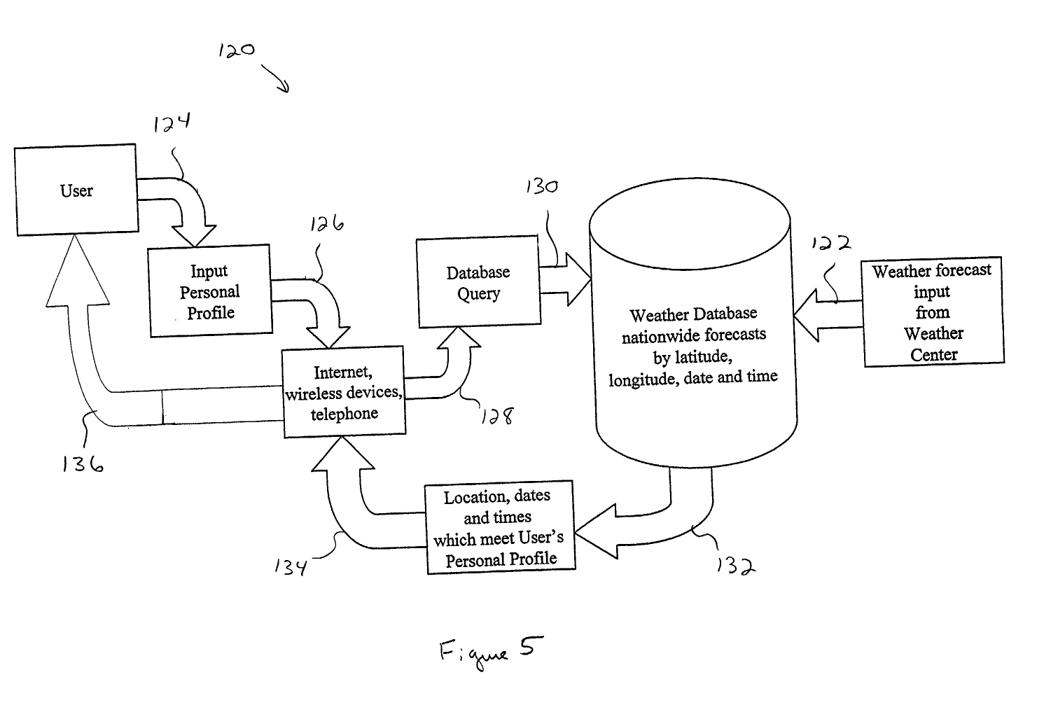

Set forth below are details regarding exemplary hardware architectures (FIGS. 2 and 3), an exemplary network connectivity diagram (FIG. 4) and an exemplary process flow chart illustrating information processing performed by the system (FIG. 5).

FIG. 2 is a block diagram of a system 10 that includes a server sub-system 12, sometimes referred to herein as server 12, and a plurality of user devices 14 connected to server 12. In one embodiment, devices 14 are computers including a web browser, and server 12 is accessible to devices 14 via a network such as an intranet or a wide area network such as the Internet. In an alternative embodiment, devices 14 are servers for a network of customer devices.

Devices 14 are interconnected to the network, such as a local area network (LAN) or a wide area network (WAN), through many interfaces including dial-in-connections, cable modems and high-speed lines. Alternatively, devices 14 are any device capable of interconnecting to a network including a web-based phone, pager or other web-based connectable equipment. Server 12 includes a database server 16 connected to a centralized database 18. In one embodiment, centralized database 18 is stored on database server 16 and is accessed by users at one of customer devices 14 by logging onto server sub-system 12 through one of customer devices 14. In an alternative embodiment centralized database 18 is stored remotely from server 12.

FIG. 3 is a block diagram of a network based system 22 including server sub-system 12 and user devices 14. Server sub-system 12 includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator work station 38, a work station 40, and a supervisor work station 42 are coupled to LAN 36. Alternatively, work stations 38, 40, and 42 are coupled to LAN 36 via an Internet link or are connected through an intranet.

Each work station 38, 40, and 42 is a personal computer including a web browser. Although the functions performed at the work stations typically are illustrated as being performed at respective work stations 38, 40, and 42, such functions can be performed at one of many personal computers coupled to LAN 36. Work stations 38, 40, and 42 are illustrated as being associated with separate functions only to facilitate an understanding of the different types of functions that can be performed by individuals having access to LAN 36.

Server sub-system 12 is configured to be communicatively coupled to various individuals or employees 44 and to third parties, e.g., customers, 46 via an ISP Internet connection 48. The communication in the exemplary embodiment is illustrated as being performed via the Internet, however, any other wide area network (WAN) type communication can be utilized in other embodiments, i.e., the systems and processes are not limited to being practiced via the Internet. In addition, and rather than a WAN 50, local area network 36 could be used in place of WAN 50.

In the exemplary embodiment, any employee 44 or customer 46 having a work station can access server sub-system 12. One of customer devices 14 includes a work station 54 located at a remote location. The work stations are personal computers including a web browser. Also, the work stations are configured to communicate with server sub-system 12. Furthermore, fax server 28 communicates with employees 44 and customers 46 located outside the business entity and any of the remotely located customer systems, including a customer system 56 via a telephone link. Fax server 28 is configured to communicate with other work stations 38, 40, and 42 as well.

FIG. 4 is a block diagram illustrating network connectivity of a weather-based decision making system 60 including a NOAA port receiver 62 that feeds information to a NOAA port processor 64. NOAA port processor 64 is connected to a text data processor 66, a weather imagery store 68 and a weather predicting sub-system 70 via a weather feed network segment 72. Text data processor 66, weather imagery store 68 and weather predicting sub-system 70 output processed information to a pavement temperature forecast sub-system 74, a spatial product database 76, and a product generation segment 78 via a weather network feed segment 80. In addition, pavement temperature forecast sub-system 74 provides information directly to spatial product database 76 which provides information directly to product generation segment 78.

A weather communication server 82 receives information via a network 84, such as the Internet, a PSTN, a LAN or a WAN from remote weather towers 86. The information is provided to a current weather database 88. In addition, weather reports are also received from drivers 90, video cameras 92, and construction and closures reports 94. The weather reports are received by a traffic communications server 96 via a network connection 98, such as the Internet, a PSTN, a LAN or a WAN. Traffic communications server 96 feeds information to current weather database 88.

Product generation segment 78 receives information from weather feed segment 80 and spatial product database 76 as well as current weather database 88. Product generation segment 78 communicates with archive database 100, geographic information database 102 and customer account database 104 and transfers information to and from the databases. Product generation segment 78 provides information to data storage devices 106, 108 and 110 which are accessed by servers 112, 114, and 116, respectively.

Although the servers are illustrated in FIG. 4 as being geographically remote, the server functionality can be combined into one centrally located server. As used herein, therefore, the term server includes both a single server as well as interconnected distributed servers.

In one specific exemplary embodiment, the following commercially available hardware and software are utilized: Web Server platform Windows NT 4.0 SP 5; Database Server platform Windows NT 4.0; Internet Information Server (IIS) 4.0; Microsoft Transaction Server (MTS); COM objects using VB 6.0 dlls; Active Server Pages 3.0; JScript 5.0; VBScript 5.0; and Database Oracle 7.3.4. The extranet site operates under IE 4.0 and Netscape 4.0.

FIG. 5 is a flow chart illustrating process steps of a method 120 for providing weather-based decisions to a user. A weather center, e.g., a private weather center or a service, such as the National Weather Service, generates data to be input into a weather database. The data is input 122 into the weather database and is associated with a plurality of parameters, e.g., latitude, longitude, and time. Thus a weather database is generated that includes current weather forecasts for specific locations and times. After a user logs on to a weather-based decision making system (such as system 60 shown in FIG. 4), the system displays 124 a graphical user interface to the user to prompt the user to enter 126 a personal weather profile for a specific activity. The profile includes weather parameters such as precipitation, wind, air temperature, humidity, location (latitude and longitude), road conditions, cross winds, visibility and time, as well as other parameters pertinent to the specific activity chosen by the user. The parameters can be entered as either a discreet number (3:00 PM Saturday, May 25, 2001), a range (65-75 degrees Fahrenheit), or maximums and minimums (less than 60% humidity), for a given time and/or location.

Once the profile information is input, the information is transmitted 128 to the system. The information is transmitted through the Internet, via wireless communication devices, or via a telephone/fax. The system stores the received profile in a user database. The system then compares 130 the pre-stored forecasted weather information included in the weather database with the input user profile utilizing database query software. The system determines 132 if the specified parameters are met or exceeded by any weather entries, and if so, notifies the user. The user is notified by sending information pertaining to the dates, times, and locations at which the user's weather parameters will be met or exceeded . The system transmits 134 the notification information through the Internet, via wireless communication devices, or via a telephone/fax and displays 136 the information to the user via a user interface. In one embodiment, the system has access to a user's electronic calendar and enters the time, location, and activity information directly in the calendar. Accessing personal calendars and creating entries therein is well known in the art.

In a further embodiment, a weather analyst reviews the selection determined by the system. The weather analyst interprets the weather data and provides additional input regarding the system generated selections. The system then incorporates the weather analyst's information into the existing information obtained by the system and transmits one or more appropriate predictions to the user. In an alternative embodiment, the weather analyst reviews the system selections and determines an appropriate grouping of selections to transmit to the user. The weather information provided by the system, in one embodiment, is considered to be granular to about a 5 mile grid, due to the number and location of weather observation and transmission points. In addition, the predicted times for the activities can be provided based on hourly weather changes.

As an example, a user desires to play golf at a specific course (course x) when the temperature is between 65° and 90° F. and the humidity is below 70%. The individual is available for playing golf on Tuesdays all day, Thursday morning, or Friday afternoons. The user accesses system 10 and inputs the relevant information, i.e., the user's personal profile. The information is then transmitted to system 10. System 10 searches the pre-stored forecasted weather information and compares the pre-stored information with the information input by the user. System 10 notifies the user of appropriate dates and times when the forecasted weather conditions meet the user's personal profile. The notification occurs by system 10 accessing the user's electronic calendar and creating an entry for golf on the appropriate day at the appropriate time. If for some reason the user already has another activity scheduled for the selected time, system 10 searches for the next possible date and time when the forecasted weather is projected to meet the parameters of the user's profile.

While the invention has been described in terms of various specific embodiments, those skilled in the art will recognize that the invention can be practiced with modification within the spirit and scope of the claims.

What is claimed is:

1. A weather-based decision making method utilizing an input device and at least one server, said method comprising the steps of:
receiving a user preference profile for a specific activity;
comparing the user preference profile with pre-stored weather information; and
providing the user at least one of a suggested time and a suggested location for the specific activity.

2. A method in accordance with claim 1 wherein said step of receiving a user preference profile comprises the step of receiving from the input device a user preference profile for at least one activity.

3. A method in accordance with claim 1 wherein said step of receiving a user profile comprises the step of receiving weather parameters including at least one of precipitation, wind, air temperature, humidity, location, road conditions, cross winds, visibility and time.

4. A method in accordance with claim 1 further comprising the step of receiving updated weather information and storing the weather related information in a weather database.

5. A method in accordance with claim 4 wherein said step of comparing the user preference profile comprises the step of comparing the user preference profile with information contained in the weather database.

6. A method in accordance with claim 4 further comprising the step of monitoring the weather database and providing updated information to the user.

7. A method in accordance with claim 1 further comprising the step of warning the user when input weather parameters have been exceeded.

8. A method in accordance with claim 1 further comprising the step of warning the user when input weather parameters have been met.

9. A method in accordance with claim 1 further comprising the step of determining whether one or more input weather parameters have been exceeded.

10. A method in accordance with claim 1 further comprising the step of determining whether one or more input weather parameters have been met.

11. A method in accordance with claim 4 further comprising the step of receiving weather information from at least one of NOAA reports, weather towers, traffic, video, and construction and closure reports.

12. A method in accordance with claim 4 further comprising the step of receiving weather information from a plurality of surface mounted road sensors.

13. A method in accordance with claim 1 wherein said step of providing the user at least one of a suggested time and a suggested location comprises the step of providing the user a suggested time and suggested location via a network.

14. A method in accordance with claim 1 wherein said step of providing the user at least one of a suggested time and a suggested location via a network comprises the step of creating an entry in a personal electronic calendar for a time and a location at which weather parameters in the user preference profile are forecasted to be at least one of met and exceeded.

15. A method in accordance with claim 13 wherein the network is one of the Internet, an intranet, a wide area network, and a local are network.

16. A method in accordance with claim 3 wherein the location parameter includes a latitude and longitude for the activity.

17. A system for providing weather-based decisions, said system comprising:
a database comprising weather information; and
a server configured to prompt a user to provide a user profile for a specific activity, compare the user profile with forecasted weather information prestored in said database, and provide the user with at least one of a suggested time and a suggested location for the specific activity.

18. A system in accordance with claim 17 wherein to prompt a user to provide a user profile, said server causes to be displayed on a user device a computer generated screen listing a plurality of weather parameter selections.

19. A system in accordance with claim 17 wherein said server further configured to update weather forecasts into said database.

20. A system in accordance with claim 19 wherein to compare the user profile, said server configured to compare the user profile with updated forecasted weather information stored in said database.

21. A system in accordance with claim 17 wherein said server further configured to determine if any user profile weather parameters are exceeded by the information stored in said database, the weather parameters including precipitation, wind, air temperature, humidity, location, road conditions, cross winds, visibility and time.

22. A system in accordance with claim 17 wherein said server further configured to determine if any user profile weather parameters are met by the information stored in said database, the weather parameters including precipitation, wind, air temperature, humidity, location, road conditions, cross winds, visibility and time.

23. A system in accordance with claim 17 wherein to provide the user with at least one of a suggested time and a suggested location, said server causes to be displayed on a user device information related to appropriate times and locations for the specific activity to be performed during which times the weather conditions at those locations fall within the parameter selections made by the user.

24. A system in accordance with claim 17 wherein to provide the user with at least one of a suggested time and a suggested location comprises the step of providing the user with a suggested time and suggested location via a network.

25. A system in accordance with claim 24 wherein to provide the user with at least one of a suggested time and a suggested location via a network comprises the step of creating an entry in a personal electronic calendar for a time and a location at which weather parameters in the user preference profile are forecasted to be at least one of met and exceeded.

26. A computer programmed to:
prompt a user to provide a user profile for a specific activity;
compare the user profile with forecasted weather information pre-stored in said database; and
provide the user with at least one of a suggested time and a suggested location for the specific activity.

27. A computer in accordance with claim 26 wherein to prompt a user to provide a user profile, said computer causes to be displayed on a user device a computer generated screen listing a plurality of weather parameter selections.

28. A computer in accordance with claim 26 wherein said computer further configured to update the pre-stored forecasted weather information, said computer configured to compare the user profile with updated, pre-stored, forecasted weather information.

29. A computer in accordance with claim 26 wherein said computer further configured to determine if any user profile weather parameters are exceeded by the pre-stored weather information.

30. A computer in accordance with claim 26 wherein said computer further configured to determine if any user profile weather parameters are exceeded by the pre-stored weather information.

31. A computer in accordance with claim 27 wherein to provide the user with at least one of a suggested time and a suggested location, said computer causes to be displayed on a user device information related to appropriate times and locations for the specific activity to be performed during which times the weather conditions at those locations are forecasted to fall within the parameter s elections made by the user.

32. A computer in accordance with claim 26 wherein to provide the user with at least one of a suggested time and a suggested location, said computer causes to be displayed on a user device information related to a suggested time and a suggested location via a network.

33. A computer in accordance with claim 32 wherein to provide the user with at least one of a suggested time and a suggested location via a network, said computer causes an entry to be created in a personal electronic calendar for a time and a location at which weather parameters in the user preference profile are forecasted to be met.

34. A computer in accordance with claim 32 wherein to provide the user with at least one of a suggested time and a suggested location via a network, said computer causes an entry to be created in a personal electronic calendar for a time and a location at which weather parameters in the user preference profile are forecasted to be exceeded.
